(19) United States
(12) Patent Application Publication
(10) Pub. No.: US 2009/0008471 A1
(43) Pub. Date: Jan. 8, 2009

(54) Control Devices For Irrigation Systems

(76) Inventor: Chadwick Loring Wilson, Woodscross, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/772,663

(22) Filed: Jul. 2, 2007

(51) Int. Cl. A01G 25/16; A01G 25/00; A01G 27/00

(52) U.S. Cl. 239/69; 239/1; 239/276; 239/70

(57) ABSTRACT

Control devices for irrigation systems and the associated methods for making and using such devices to control irrigation systems are described. The control devices contain a timer that can be mounted to a fixed location that is remote from a plurality of valves for the sprinkler system. The timer receives instructions that can be entered directly into the timer or the instructions can be entered remotely using another remote interface tool, such as a wirelessly connected personal computer (PC) or radio frequency (RF) programming device. Thus, the control devices are portable and can be easily removed and programmed away from the electrical interface typically used to control its programming when they are mounted at a fixed location. Second, when the control devices are removed from the fixed location containing the electrical interface, they still retain their programming even though it is no longer connected to the electrical interface.

### FIELD

The present application relates, in general, to control devices for irrigation systems. In particular, the present application relates to sprinkling timing devices and associated methods for making and using such devices for controlling sprinkling systems and other types of irrigation systems.

### BACKGROUND

The use of irrigation systems in yards, small farms, and greenhouses is widely accepted for distribution of liquid, including water and sometimes chemical additives, to a specified area (usually containing plants and grass). One type of irrigation system, a sprinkling system, receives the liquid from a liquid source and distributes the liquid to various types of sprinklers containing sprinkler heads. The sprinkler heads in turn distribute the liquid to the plants and grass in the specified area with the minimum amount of liquid needed, while also providing proper coverage of the entire area. As the volumetric pressure from the liquid source is usually limited, several zones are generally established and the liquid distribution is rotated between the zones so that sufficient pressure for distribution is always present at each sprinkler head.

In some instances, each zone can be manually operated by turning on a valve that allows sufficient flow of the liquid to that zone. In other words, an individual manually needs to decide the time needed for proper distribution of the liquid to a specific zone and operate the valves as necessary. These zone systems for irrigation can, therefore, require a large amount of manual labor and time for proper operation. And since they operate manually, they can not be used when the operator is not present, i.e., they can not be used in a home when the home owner is on vacation.

In other instances, though, the irrigation zones may have a centralized location where valves for each zone may located and controlled. These configurations reduce or eliminate the need for manual operation of zones because an electromechanical control system can be used at the centralized location. The control system uses electrical wires that control the opening and closing of the valves. The electrical wires are connected to a timer that may be located at the centralized location or at a remote location, such the exterior of a wall (often fairly near to the centralized), or in a building so as to not be visually obtrusive.

While the timer devices partially automate the irrigation process, such timers typically have a limited flexibility and operability. They typically only have an analog type interface with pegs on rotary wheels that mechanically move to trigger the valve when the pegs are aligned with the designated “on” position on the timer. As well, system maintenance of the valves at the centralized location along with programming the timer can be clumsy and difficult. Often it requires many trips from the location where the valves can be accessed, to the timer to make adjustments to the timing sequence, and then back to the valves, and then back to the timer, and so forth. This is further complicated when the user also needs to access individual sprinklers in this process of maintaining the sprinkling system.

### SUMMARY

Control devices for irrigation systems and the associated methods for making and using such devices to control irrigation systems are described in this application. The control devices contain a timer that can be mounted to a fixed location that is remote from a plurality of valves for the sprinkler system. The timer receives instructions that can be entered directly into the timer or the instructions can be entered remotely using another remote interface tool, such as a wirelessly connected personal computer (PC) or radio frequency (RF) programming device. Thus, the control devices are portable and can be easily removed and programmed away from the electrical interface typically used to control its programming when they are mounted at a fixed location. Second, when the control devices are removed from the fixed location containing the electrical interface, they still retain their programming even though it is no longer connected to the electrical interface.

### BRIEF DESCRIPTION OF THE DRAWINGS

The following description can be better understood in light of Figures, in which:

FIG. 1 illustrates one example of a timer used in a control devices for an irrigation system;

FIG. 2 depicts an exemplary mounting assembly for a timer;

FIG. 3 illustrates a rear view of a timer detached from a mounting assembly;

FIG. 4 depicts an example of how the timer is separable from a mounting assembly;

FIG. 5 shows how an example of how the mounting assembly could be wired to a transformer; and

FIG. 6 shows how the mounting assembly would be wired to a plurality of irrigation zones.

Together with the following description, the Figures demonstrate and explain the principles of the control devices and the associated methods for making and using such devices to control sprinkler systems. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the devices and associated methods of using the devices can be implemented and used without employing these specific details. Indeed, the devices and associated methods can be placed into practice by modifying the illustrated devices and can be used in conjunction with any devices and techniques conventionally used in the industry. For example, while the description below focuses on control device used to control a sprinkling system in a residential yard, these devices may be implemented in many other applications and end uses, such as controlling the kinds and amounts of chemical additives, controlling non-sprinkling systems, or controlling irrigation systems for an arbor or a greenhouse.

The control devices are used to control the operation of valves operating a plurality of watering zones in a residential sprinkling system. Typically, the control devices are mounted to a fixed location, such as externally on a home exterior (such as a utility panel) near the valves (i.e., so the valves may be manually overridden while standing near the control device). Alternatively, the control devices can be placed remote from the valves in a garage or basement of a home. Indeed, the control devices can be mounted to any desired location.

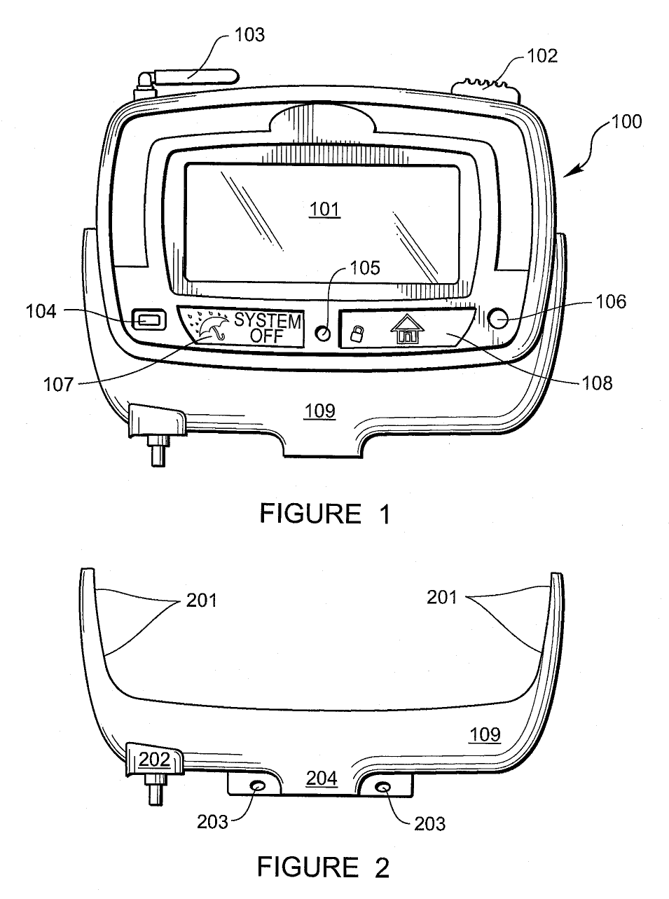

The control devices of the invention contain a timing device (or timer) that controls the valves for irrigation zones. FIG. 1 illustrates one view of the timing device the can be used in the control devices. The timer 100 contains a control program that determines start, stop, running durations, and other parameters for one or more watering or irrigation zones and correspondingly sends electrical control signals to control corresponding valves that allow water to irrigate each programmed zone. The timing device comprises multiple features that enhance the ability of a user to control and re-write the control program, as necessary.

The control program for the timing device can be any computer software or programming technology known in the art. One example of a programming technology that can be used is disclosed in the co-pending U.S. patent application Ser. No. ______ (Attorney Docket No. 8728.015) entitled “Control Devices For Irrigation Systems and Methods for Programming”, filed concurrently herewith and the disclosure of which is incorporated herein by reference.

The timing device 100 may contain a memory device, such as an EEPROM module (not shown) that embodies the control program for the sprinkling system. Thus, the control program will not be lost in the event of a complete power failure to the timing device. The timing device is also comprised of a screen 101 for viewing the control program. The screen 101 may be any type of screen as known in the art, including an LCD screen as shown, that allows for touch screen interaction by the user of the timing device.

The screen 101 may be controlled via any suitable mechanism known in the art. One example of control mechanism comprises a pointing device, such as stylus 102. The stylus may be conveniently stored out of view in a holder found on the timer's housing. The stylus 102 (or a finger) may be used to navigate the LCD screen to view and interact with the control program.

In some embodiments, the timer 100 may contain a radio frequency (“RF”) receiver and RF antennae 103, a USB port (not shown), a precipitation sensor 104, a reset button 105, a RF synchronization button 106, an override control 107, and a screen lock feature 108. In other embodiments, the timer 100 can contain any other components that help it operate in the manner described herein.

The RF receiver and antennae 103, along with the USB port, provide for numerous ways of programming the timer 100 remotely. With the RF receiver and RF antennae, a user may carry a separate programming device (containing an RF transmitter) that can synchronize to the timer through the RF synchronization sensor 106 and later transmit programming instructions via RF transmission to the timing device. This configuration allows the user to program the timer remotely so that the user can be on location with the various valves and their corresponding watering zones, or even at an individual sprinkler. Alternatively, a user can program from a personal computer (“PC”) or other computing system (such as a portable computing device like a laptop PC or any type of personal digital assistant, or even a properly-configured cellular telephone) that has an interface with the timer 100. In this configuration, the USB port (not shown) may be connected to the PC using any known wired technologies, such as Ethernet, or any known wireless technologies, such as 802.11 standards. In another configuration, the programming could be performed remotely and then uploaded by using a flash drive.

The precipitation sensor 104 in the timer can be used to sense precipitation as known in the art. In some instances, the precipitation can be sensed directly if the timer (that contains the sensor 104) is mounted near the irrigation zone valves. In other instances, the precipitation can be sensed indirectly by using a remote sensor and sending the signal from the remote sensor to the timer using any known wired or wireless technology. The precipitation sensor, whether located in the timer or located in a remote sensor, allows the control device containing the timer to control the valves and stop the irrigation if precipitation reaches a predetermined level for a predetermined duration. Alternatively, since the timing device can be connected to a PC or similar device described above (and using the PC, to information data sources such as the internet), the timing device could utilize precipitation information from a local, regional or other registry (including the national weather service) and utilize that information from these databases to control the timing device as needed.

The timer 100 can also contain a reset mechanism, such as reset button 105. The reset mechanism may be used for setting the timing device back to factory settings should it become non responsive or over programmed.

The timer can also contain an override mechanism for the control program, such as program override button 107. The override mechanism can be used to terminate the control program during a sudden storm, tornado, or other severe weather pattern (including a drought) where interrupting or overriding the control program is needed or is required by local authorities. The override mechanism could be set with any desired parameters, for example, to require restarting the control program manually or to terminate the interruption and return to normal programming after a certain delay period (such as a twenty-four hour latency period to accommodate forgetful users).

To prevent accidental reprogramming, the timer can contain a locking mechanism, such as a system or screen lock 108. The locking mechanism provides easy access to the control program of the timer while simultaneously preventing the screen 101 from being accidentally triggered to reprogram or terminate active programming. Optionally, the locking mechanism may also function as a home navigating button to quickly help the user navigate to the main program screen.

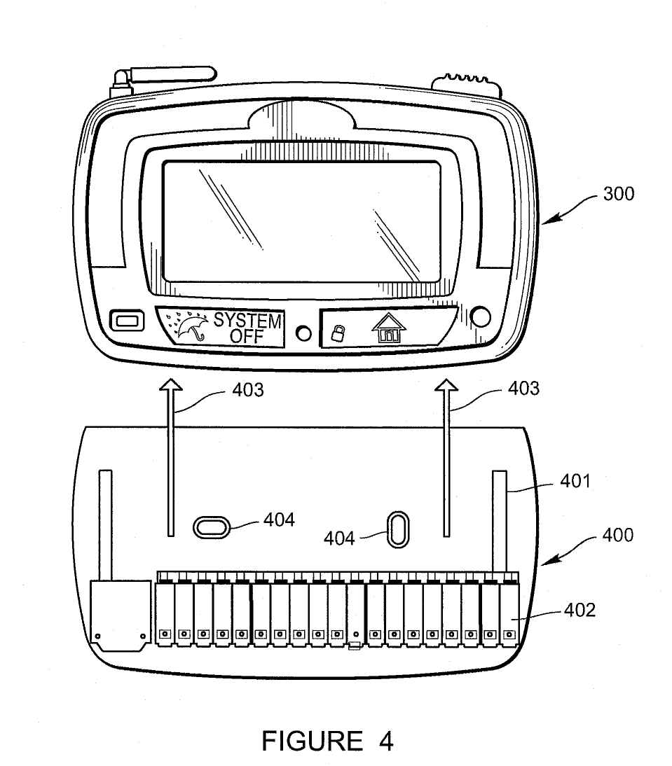

The timer 100 can be connected to any known mounting assembly, such as base 109. The mounting assembly fixes the timer to a specific location (such as a wall) and thereby makes the timer easier to use and highly visible. The mounting assembly, as seen in FIG. 2, may also function to house wires (not shown) running into the timer 100. For example, the base 109 in FIG. 2 contains an outlet for a wireless USB connector 202, two mounting holes 203, and a housing 204 for organizing wires for an AC adaptor and wires corresponding to one or more watering zone valve controls. A plurality of mounting depressions 201 along with a docking station 400 (as shown in FIG. 4) with corresponding mounting depressions (not shown) allow the timer 100 to be mounted to the base 109 while allowing the timer to be detachable and programmed independent of all wiring.

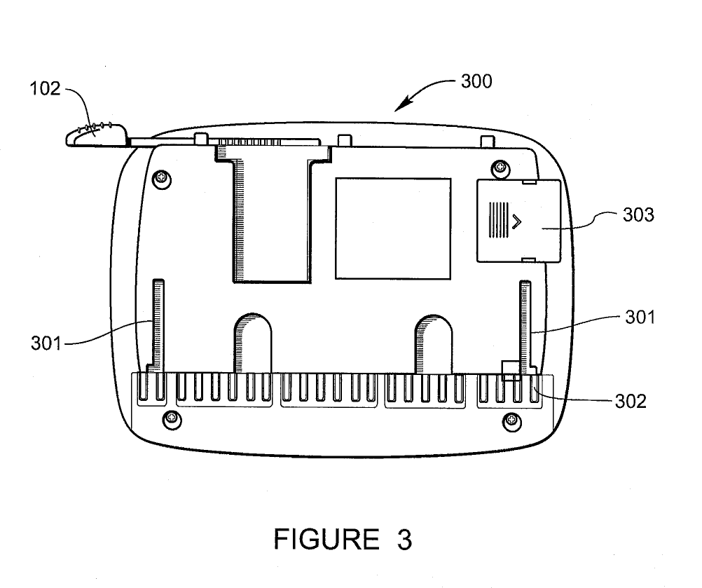

FIGS. 3 and 4 illustrate some portable aspects of the timer. In these aspects, detachable or portable timer 300 is mounted on docking station 400. FIG. 3 depicts a rear view of the timer 300. Locking slots 301 slide into corresponding sliding guides 401 and guide the timer 300 when it is mounted to the docking station 400. The slides 301 and sliding guides 401 make it so the electrical male connectors 302 may properly interlock into corresponding female receptors 402. This configuration, along with a power source (such as a battery 303) allows the user to quickly and easily remove the timer 300 so it may be taken to any location and programmed. This configuration allows simple sprinkling system diagnostics and programming as a user can program from the convenience of one location; i.e. where the valves are located or at a specific sprinkler in any given irrigation zone.

FIG. 4 shows how the timer 300 can slide into the docking station 400 by way of directional indicators 403. Once together, the timing docking station 400 is mostly hidden from sight by the timer 300. If desired, the docking station 400 may additionally be mounted to the fixed locations (i.e., the wall) through mounting holes 404 along with the base 109 of FIG. 2 to provide more strength and stability to the timer 300.

The docking station 400 can be in electronic communication with the valves of irrigation system as known in the art. In some embodiments, the docking station uses wireless communication technologies to communicate with the valves (when the valves are also fit with the corresponding wireless technology). In other embodiments, though, the docking station uses wired communication technology. In these embodiments, the docking station can contain an electrical interface, such a terminal center, that connects the timer to the wires coming from the valves.

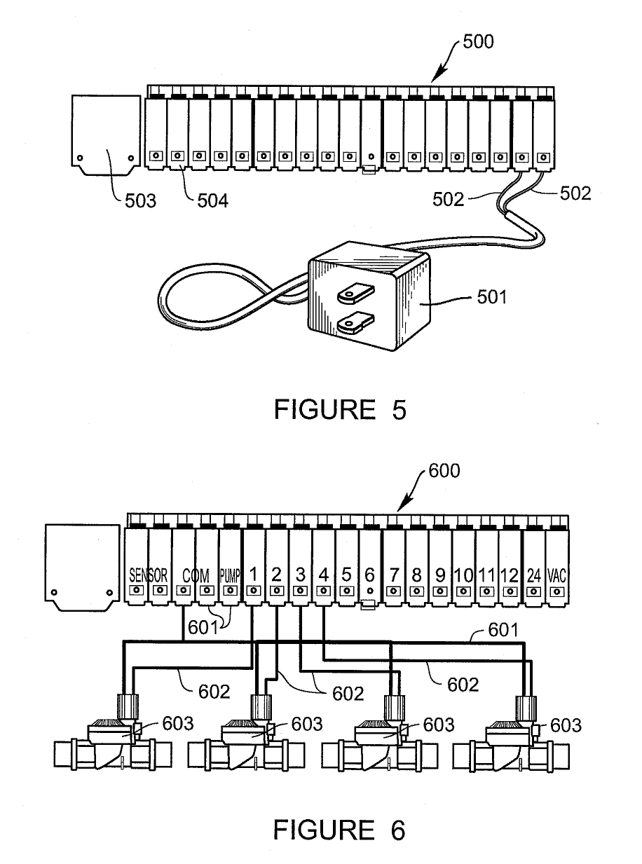

FIG. 5 shows one example of a terminal center 500 that can be used in the docking station 400. A transformer 501 is connected to terminals designated for AC connections 502. Similarly, a USB port 503 may be connected to a wireless USB transmitter or to a USB hub and a precipitation sensor (such as that described above) may be remotely connected at other port terminals 504. Other controls known in the art, such as a water pump or an Ethernet port can also be included in the terminal center 500.

FIG. 6 shows an example of how the terminal center is then connected to the valves. In FIG. 6, a plurality of electrical controls is wired into the port terminals buttons to control valves from multiple zones as known in the art. A common terminal 601 can be provided for ground wires while wires of sufficient length 602 can then be connected to the port terminals and to corresponding zone control valves 603.

Using the control devices containing the timers described above provides several advantages. First, the timer is portable and can be easily removed and programmed away from the electrical interface typically used to control its programming when it is mounted at a fixed location. Second, when the control devices are removed from the fixed location containing the electrical interface, they still retain their programming even though they are no longer connected to the electrical interface.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

We claim:

1. A control device for an irrigation system, comprising:
a docking station electrically connected to an irrigation valve; and
a portable, programmable timer that controls the functionality of the irrigation valve and is fully programmable when disconnected from the docking station, the timer comprising an interactive LCD screen and a device for interacting with the interactive LCD screen to program the programmable timer.

2. The control device of claim 1, further comprising a mounting assembly for mounting the timer to fixed location.

3. The control device of claim 1, further comprising a RF receiver, a RF antennae, and a synchronization sensor allowing a RF controller to be synched with and remotely program the timer.

4. The control device of claim 1, further comprising a precipitation sensor that overrides the timer when sensed precipitation reaches a predefined level.

5. The control device of claim 1, further comprising a system reset for resetting the programmable timer to default settings.

6. The control device of claim 1, further comprising an override for interrupting the programmable timer.

7. The control device of claim 1, further comprising a lock for preventing accidental programming of the programmable timer.

8. The control device of claim 1, further comprising memory capable of retaining a programmed control when the timer is removed from the docking station.

9. The control device of claim 1, further comprising an interface for allowing remote programming via a remote computing device.

10. A control device for an irrigation system, comprising:
a docking station containing an electrical interface which is electrically connected to an irrigation valve;
a portable, programmable timer that controls the functionality of the irrigation valve and is fully programmable when disconnected from the docking station, the timer comprising an interactive LCD screen and a device for interacting with the interactive LCD screen to program the programmable timer; and
a mounting assembly for mounting the docking station to fixed location.

11. The control device of claim 10, further comprising a RF receiver, a RF antennae, and a synchronization sensor allowing a RF controller to be synched with and remotely program the timer.

12. The control device of claim 10, further comprising a precipitation sensor that overrides the timer when sensed precipitation reaches a predefined level.

13. The control device of claim 10, further comprising memory capable of retaining a programmed control when the timer is removed from the docking station.

14. The control device of claim 13, wherein the memory comprises an EEPROM module which can retain the programmed sequence during a power failure.

15. A control device for an irrigation system, comprising:
a docking station containing a power supply and an electrical interface which comprises a port for connecting to an irrigation valve;
a portable, programmable timer that controls the functionality of the irrigation valve and is fully programmable when disconnected from the docking station containing:
memory capable of retaining a programmed control when the timer is removed from the docking station;
a portable power source; and
a mounting assembly for mounting the docking station to fixed location.

16. The control device of claim 15, further comprising a precipitation sensor that overrides the timer when sensed precipitation reaches a predefined level.

17. The control device of claim 15, further comprising an interactive LCD screen and a device for interacting with the interactive LCD screen to program the programmable timer.

18. An irrigation system, comprising:
a valve for controlling the flow of water to an irrigation zone; and
a control device comprising a docking station electrically connected to the valve, the control device containing:
a docking station containing an electrical interface which is electrically connected to the irrigation valve;
a portable, programmable timer that controls the functionality of the irrigation valve and is fully programmable when disconnected from the docking station; and
a mounting assembly for mounting the docking station to fixed location.

19. The irrigation system of claim 18, wherein:
the docking station further comprises a power supply and an electrical interface which comprises a port for connecting to the valve; and
the timer further comprises memory capable of retaining a programmed control when the timer is removed from the docking station and a portable power source.

20. The irrigation system of claim 18, further comprising an interactive LCD screen and a device for interacting with the interactive LCD screen to program the programmable timer.

21. A method for irrigating, comprising:
providing a valve for controlling the flow of water to an irrigation zone; and
connecting a control device to the valve, the control device containing:
a docking station containing an electrical interface which is electrically connected to an irrigation valve;
a portable, programmable timer that controls the functionality of the irrigation valve and is fully programmable when disconnected from the docking station; and
a mounting assembly for mounting the docking station to fixed location.

22. The method of claim 21, further comprising:
providing the docking station with a power supply and the electrical interface with a port for connecting to the valve; and
providing the timer with memory capable of retaining a programmed control when the timer is removed from the docking station and a portable power source.

23. The method of claim 21, further comprising providing the timer with an interactive LCD screen and a device for interacting with the interactive LCD screen to program the programmable timer.
